(19) United States
(12) Patent Application Publication
(10) Pub. No.: US 2010/0232257 A1
(43) Pub. Date: Sep. 16, 2010

(54) ULTRASONIC PROBE AND ULTRASONIC IMAGING DEVICE

(76) Inventors: Hiroki Tanaka, Musashino (JP); Shuntaro Machida, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/438,388

(22) PCT Filed: Jul. 25, 2007
(86) PCT No.: PCT/JP2007/064544

§ 371 Date: Feb. 23, 2009

(30) Foreign Application Priority Data
Sep. 28, 2006 (JP) 2006-264160

(51) Int. Cl. G03B 42/06; H02N 11/00

(52) U.S. Cl. 367/7; 310/300

(57) ABSTRACT

Provided is an ultrasonic probe for simultaneously achieving improvement of both of a generatable sound pressure and a gain. An upper electrode 3 is provided as a separate element from a diaphragm 6, is fixed to a part of the diaphragm through a binding site 8, and thus is arranged between the diaphragm 6 and a lower electrode 2.

### TECHNICAL FIELD

The present invention relates to an ultrasonic probe and an ultrasonic imaging device, and particularly relates to an ultrasonic probe and an ultrasonic imaging device using a diaphragm-type ultrasonic transducer.

### BACKGROUND ART

Many of ultrasonic transducers currently used in ultrasonic probes transmit and receive ultrasonic waves by using the piezoelectric effect and the inverse piezoelectric effect of a piezoelectric substance of a piezoelectric ceramics base such as PZT (lead zirconate titanate), for example.

Patent Document 1 describes a capacitive ultrasonic transducer provided with a compliant support structure on a supporting portion for a diaphragm and configured so that the support structure around the membrane (diaphragm) can vibrate in order to improve the transmission gain and the receive gain of this diaphragm-type transducer. The term “gain” in this description indicates a ratio of a generated sound pressure to a voltage applied between upper and lower electrodes of the diaphragm at a time of transmission, and a current or voltage generated between the upper and lower electrodes in response to an input sound pressure at a time of receiving.

### Patent Document 1: Japanese Patent Application Publication No. 2005-193374

### DISCLOSURE OF THE INVENTION

### Problems to be Solved by the Invention

Patent Document 1 does not give any consideration to influence of air inclusion or ingress of water to the inside of the device because the surrounding area of the diaphragm is not completely sealed. Thus, Patent Document 1 has an unsolved problem that needs to be solved to surely produce both a sound pressure and a gain by means of an appropriate cavity between upper and lower electrodes of a diaphragm.

An object of the present invention is to provide an ultrasonic probe and an ultrasonic imaging device capable of surely producing both a sound pressure and a gain by means of an appropriate cavity between upper and lower electrodes of a diaphragm.

### Means for Solving the Problem

In order to solve the foregoing problem, a capacitance-type ultrasonic transducer of the present invention has a structure in which an upper electrode is provided as a separate element from a diaphragm, is fixed to a part of the diaphragm through a binding site, and is arrange between the diaphragm and a lower electrode.

More specifically, the ultrasonic probe according to the present invention is provided with multiple ultrasonic transducers on a substrate. Each of the ultrasonic transducers includes an electrode provided on the substrate; a diaphragm whose perimeter portion is fixed to the substrate through a supporting wall; a cavity formed between the electrode on the substrate side and the diaphragm; and an electrode fixed to a part of the diaphragm through a binding site and arranged in the cavity. In a direction parallel to a surface of the electrode on the diaphragm side, the binding site has a smaller width than the electrode on the diaphragm side has. A cross section of the binding site taken in parallel with a surface of the electrode on the diaphragm side has a smaller area than that of the electrode on the diaphragm side. This ultrasonic probe is usable for an ultrasonic imaging device.

### EFFECT OF THE INVENTION

According to the present invention, the transmit gain and the receive gain of a diaphragm-type ultrasonic transducer can be improved.

### BRIEF DESCRIPTION OF THE DRAWINGS

FIG. 1 is a vertical cross-sectional view showing an ultrasonic transducer of a first embodiment.

FIG. 2 is a plan view of the ultrasonic transducer of the first embodiment.

FIG. 3 is view showing a perspective view and a probe of an ultrasonic transducer array.

FIG. 4 is a diagram showing a system configuration example of an ultrasonic imaging device.

FIG. 5 is a graph showing a frequency-gain property example of the ultrasonic transducer.

FIG. 6 is a vertical cross-sectional view showing an existing capacitance ultrasonic transducer.

FIG. 7 is a vertical cross-sectional view in a state in which a voltage is applied to an electrode in the ultrasonic transducer of the first embodiment.

FIG. 8 is a graph showing the frequency-gain property of the ultrasonic transducer.

FIG. 9 is a vertical cross-sectional view showing an ultrasonic transducer of a second embodiment.

FIG. 10 is a plan view showing the ultrasonic transducer of the second embodiment.

FIG. 11 is a plan view showing an ultrasonic transducer of a third embodiment.

FIG. 12 is a vertical cross-sectional view showing an ultrasonic transducer of a fourth embodiment.

FIG. 13 is a plan view showing the ultrasonic transducer of the fourth embodiment.

FIG. 14 is a vertical cross-sectional view showing an ultrasonic transducer of a fifth embodiment.

FIG. 15 is a plan view showing the ultrasonic transducer of the fifth embodiment.

FIG. 16 is a plan view showing an ultrasonic transducer (a hexagonal shape) of a sixth embodiment.

FIG. 17 is a plan view showing an ultrasonic transducer (a circular shape) of the sixth embodiment.

FIG. 18 is a cross sectional view showing an ultrasonic transducer of a seventh embodiment.

FIG. 19 is a diagram showing a device configuration example in the seventh embodiment.

FIG. 20 is a diagram showing frequency properties under water of transmit gains of ultrasonic transducers of an example and a comparative example.

FIG. 21 is a diagram showing frequency properties under water of receive gains of the ultrasonic transducers of the example and the comparative example.

### DESCRIPTION OF SYMBOLS

1 substrate
2 electrode (on substrate side)
3 electrode (on diaphragm side)
4 insulating layer
5 insulating layer
6 diaphragm
7 cavity
8, 8a, 8b, 8c binding site
9 inner layer
10 stiffened element
11 supporting wall
13 connection
25 insulating layer
26 diaphragm
100, 100b, 100c, 100d, 100e, 100f, 100g, 100h ultrasonic transducer
101 connection region
200 existing ultrasonic transducer
210 acoustic lens
220 acoustic matching layer
230 backing material
240 conductive film
1000 ultrasonic transducer array
2000 ultrasonic probe

### BEST MODES FOR CARRYING OUT THE INVENTION

Hereinafter, embodiments of the present invention will be described with reference to the drawings.

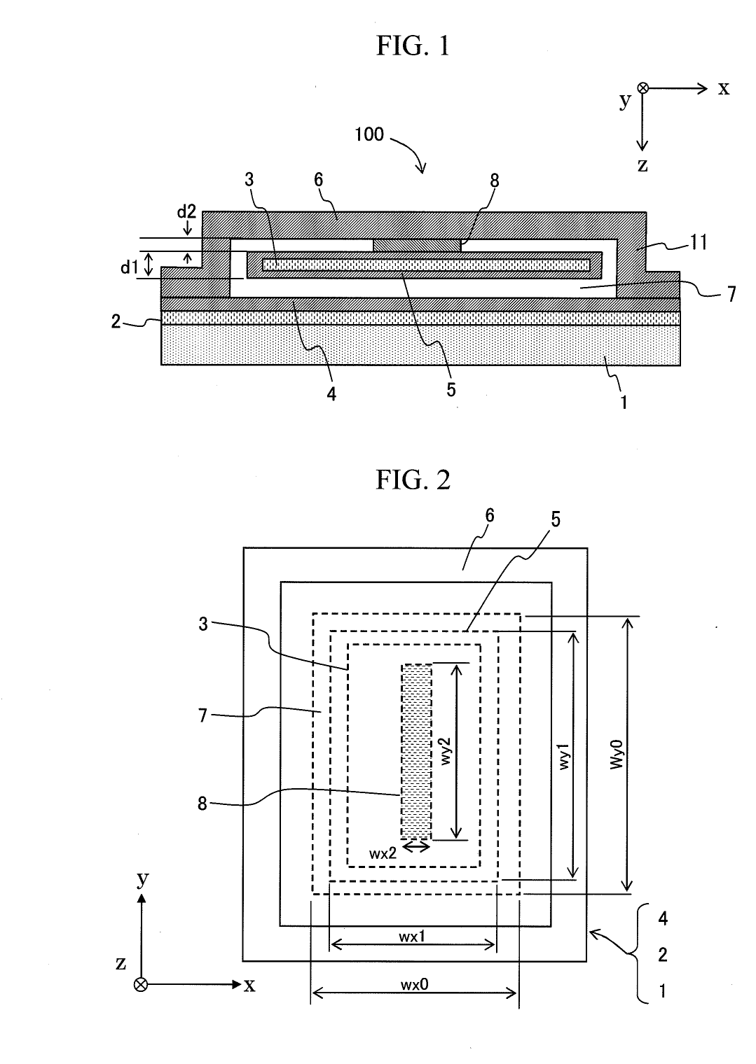

FIG. 1 is a vertical cross-sectional view showing an ultrasonic transducer of a first embodiment, and FIG. 2 is a plan view thereof. Here, for convenience of description, a z direction denotes a direction in which an ultrasonic transducer 100 receives ultrasonic waves, that is, a downward direction in FIG. 1, and a direction vertically downward from the paper surface in FIG. 2. In addition, an x direction denotes a right-hand direction in FIGS. 1 and 2, and a y direction denotes a direction vertically downward from the paper surface in FIG. 1 and an upward direction in FIG. 2.

As shown in FIGS. 1 and 2, this ultrasonic transducer 100 is a capacitance-type diaphragm transducer in which a thin-film-like electrode 2 made of a conductive material such as aluminum or tungsten is formed on a plate-like substrate 1 made of an insulating material such as silicon monocrystal or made of a semiconductor; and a diaphragm 6 is formed above the electrode 2. The perimeter portion of the diaphragm 6 is fixed to the substrate through a supporting wall 11 extending upward from the substrate. A cavity 7 is formed between the diaphragm 6 and the substrate 1, and the perimeter of the cavity 7 is hermetically sealed by the supporting wall 11. An electrode 3 coated with an insulating layer 5 is placed inside the cavity 7, and this electrode 3 is coupled to a part of the diaphragm 6 through a binding site 8. The electrode 3 is displaced toward the substrate with almost no deformation in response to an electrostatic force when a voltage is applied between the electrode 2 and the electrode 3. In order to prevent the electrode 3 from being made conductive when the electrode 3 is displaced excessively and comes into contact with the electrode 2, it is preferable to provide an insulating layer 4 on top of the electrode 2 or to coat the electrode 3 with the insulating layer 5. Incidentally, in this description, the term, the electrode is used to indicate an entire element which includes insulating layer 5 and which is coupled to the diaphragm 6 through the binding site 8 and thus is held inside the cavity 7.

The diaphragm 6 and the electrode 3 of this embodiment are rectangular. The binding site 8 connecting the diaphragm 6 to the electrode 3 is a member with a square pole shape whose longitudinal direction is aligned with the longitudinal directions of the diaphragm 6 and the electrode 3 (the y-axis direction in the case of the example in the drawings).

The diaphragm 6, the supporting wall 11, the binding site 8 and the electrode 3 coated with the insulating layer 5 are made of materials that can be processed by semiconductor process technologies. For example, the materials described in the description of U.S. Pat. No. 6,359,367 are usable. Examples of them are silicon, sapphire, any type of glass material, a polymer (such as polyimide), polycrystalline silicon, silicon nitride, silicon oxynitride, a thin metal membrane (aluminum alloy, copper alloy, tungsten or the like), a spin-on-glass (SOG), an implantable doping agent or a diffusion doping agent, and a grown film such as silicon oxide or silicon nitride. The inside of the cavity 7 may be evacuated or be filled with the air or any type of gas. Under normal conditions (out of operation), an interval (in the z direction) of the electrode 3 and the substrate 1 is maintained mainly by the stiffness of the diaphragm 6, the supporting wall 11, the binding site 8 and the electrode 3.

The ultrasonic transducer 100 operates as a variable capacitance capacitor in which the electrode 2 and the electrode 3 are arranged with the cavity 7 functioning as a dielectric, and the insulating layer 4 interposed therebetween. When the electrode 3 is displaced in the z direction upon receipt of a force, the interval of the electrode 2 and the electrode 3 is changed and thereby the capacitance of the capacitor is changed. Since the electrode 3 is coupled to the diaphragm 6 through the binding site 8, the electrode 3 is displaced even when a force is applied to the diaphragm 6. In this event, if electrical charges are accumulated in the electrode 2 and the electrode 3, a voltage is generated between these two electrodes due to the change of the capacitance caused by the change of the interval of the electrode 2 and the electrode 3. When a force, such as ultrasonic waves, that causes any mechanical displacement is propagated into the diaphragm 6 as described above, this deformation is converted into electrical signals. Meanwhile, when a potential difference is given between the electrode 2 and the electrode 3, electrical charges with different signs are respectively accumulated in these electrodes so that the electrode 3 is displaced toward the substrate 1 in response to the electrostatic force. At this time, the diaphragm 6 is also displaced concurrently, because the diaphragm 6 is coupled to the electrode 3 through the binding site 8. Thus, if a sound propagation medium such as air, water, a plastic, a rubber or an organism exists above the diaphragm (in the −z direction), sound is radiated. In summary, this ultrasonic transducer 100 is an electroacoustic transducer device having functions of converting inputted electrical signals into ultrasonic wave signals to radiate the ultrasonic wave signals to a medium adjacent to the diaphragm 6, and of converting ultrasonic wave signals inputted from the medium into electrical signals to output the electrical signals.

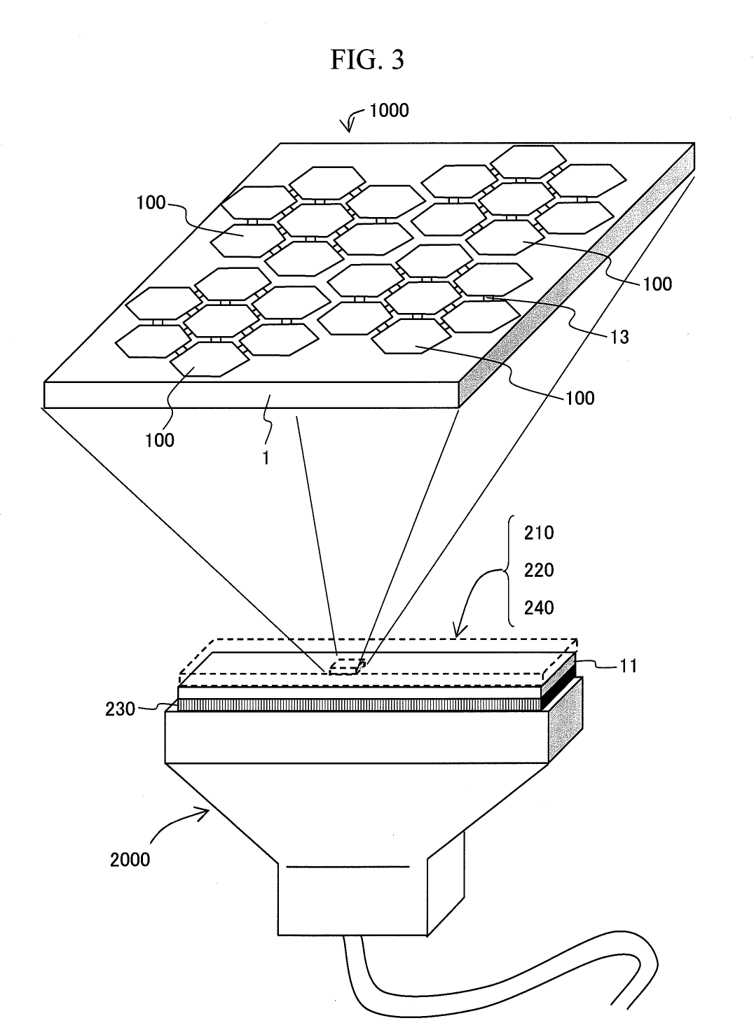

FIG. 3 is a perspective view showing an ultrasonic transducer array 1000. This ultrasonic transducer array 1000 forms a transmitting and receiving surface of an ultrasonic probe 2000. In the ultrasonic transducer array 1000, a large number of cells are formed on the substrate 1 when the fine (for example, 50 μm) ultrasonic transducer 100 mentioned above is regarded as one cell, and a predetermined number of cells are electrically connected to each other with connections 13. The cell in the drawing has a hexagonal shape, but the shape may be appropriately changed according to the purpose of use. In addition, the number of ultrasonic transducers 100 is not limited to that illustrated in the drawing. By using semiconductor manufacturing technologies, a larger number of ultrasonic transducer 100 cells may be integrated on a larger substrate.

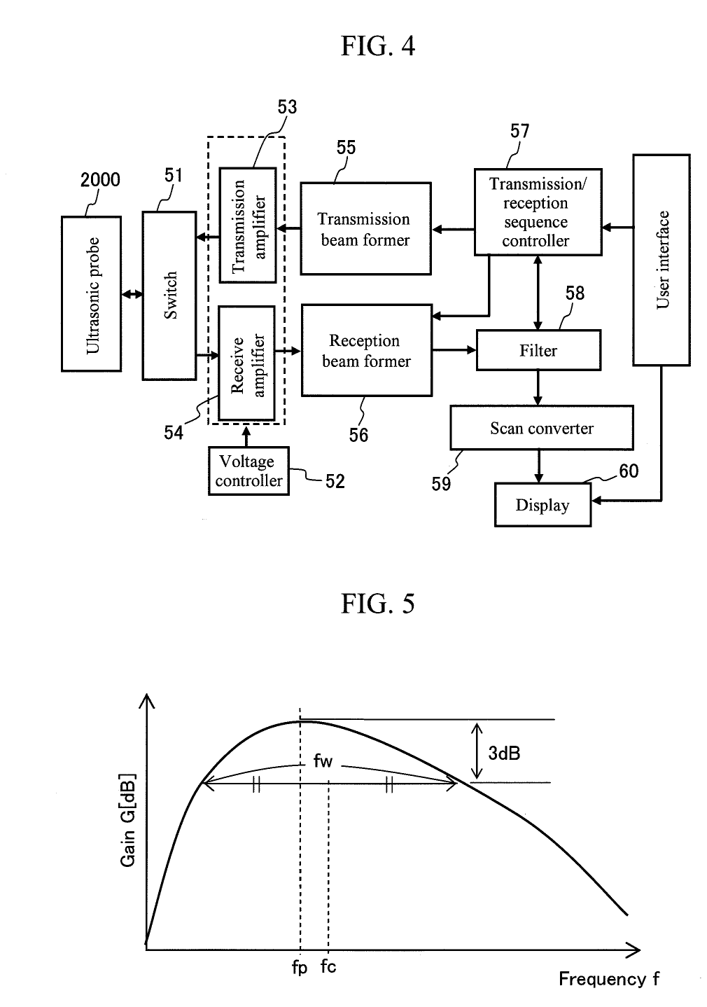

As shown in FIG. 4, individual cells or groups of a predetermined number of cells are connected through a switch 51 to a transmission beam former 55 and a reception beam former 56 of an ultrasonic imaging device including this ultrasonic probe 2000. The ultrasonic probe 2000 operates as an array that forms an ultrasonic wave beam by use of a transmission amplifier 53 and a receive amplifier 54 driven by a voltage controller 52, and is used to transmit and receive ultrasonic waves. According to the purpose of use, transmission/reception signals are controlled by a transmission/reception sequence controller 57. Reception signals are converted into video signals through a filter 58, and then are displayed on a display 60 through a scan converter 59. Incidentally, the arrangement of the ultrasonic transducers 100 shown in FIG. 3 is only one example, and other arrangement configurations such as a grid configuration in addition to the honeycomb configuration can be employed. In addition, the arrangement surface may be any one of a flat surface and a curved surface, and the shape of the arrangement surface may be a circular shape or a polygonal shape. Instead, the ultrasonic transducers 100 may be arranged in straight lines or curved lines. Hereinafter, general description will be provided for a flow from the transmission and reception of ultrasonic waves to the display of the image thereof.

In general, an ultrasonic imaging device displays a structure inside a living body in a two-dimensional plane or in three dimensions. To this end, the ultrasonic imaging device uses an array-type ultrasonic probe to perform beam forming to form beams in transmission and reception of ultrasonic waves under the condition in which an electrical delay operation for each channel or the number of channels to be used is set, and then to perform scanning and imaging by moving a focus of ultrasonic waves in two dimensions or in three dimensions. These operations are performed inside a transmission beam former 55 or a reception beam former 56. In addition, a transmission/reception sequence controller 57 controls the beam formers according to various imaging modes. A voltage is applied through the transmission amplifier to each channel in the prove controlled by the transmission beam former 55, and the ultrasonic waves radiated from the respective channels are transmitted with their phases matched with each other at a certain focus. Since the transmission and reception are performed alternately by using the same probe, the transmission and reception need to be switched by the switch 51. At the time of reception, the receive amplifier 54 amplifies reception signals and the filter 58 detects these signals through the reception beam former 56. In the filter 58, the signals are phased and added, and then are processed through steps of filter processing, logarithmic compression and wave detection. Thus, the signals are converted into data on a two-dimensional image or a three-dimensional image corresponding to acrostic field scanning before scan conversion. In the case of imaging blood flows by use of Doppler, the signals are converted into data through processing such as quadrature detection and range gate processing after processing using another filter. The data thus obtained is scan-converted by the scan converter 59, and is outputted as video signals to the display 60. A user is allowed to control the above processing and adjust the display through a user interface.

The ultrasonic probe 2000 includes a transducer array 1000 formed, for example, in an array type in which a group of ultrasonic transducers 100 are arranged in strips or in a convex type in which a group of ultrasonic transducers 100 are arranged in a fan shape. In addition, this ultrasonic probe 2000 can be used with an acoustic lens 210, an acoustic matching layer 220 and a conductive film 240 arranged at a medium (test object) side of the ultrasonic transducer 100, and with a backing material 230 provided at the back side thereof (an opposite side to the medium). Here, the acoustic lens 210 converges ultrasonic wave beams, the acoustic matching layer 220 matches the acoustic impedances of the ultrasonic transducer 100 and a medium (test object), and the backing material 230 absorbs the propagation of ultrasonic waves.

FIG. 5 is a graph showing an example of a frequency-gain property of the ultrasonic transducer 100. In the graph, the horizontal axis indicates frequency f, and the vertical axis indicates G (gain) representing electromechanical transducer performance. Here, for description, the frequency f with the maximum gain G is denoted by the center frequency fp, and a frequency band-width within a range of −3 [dB] from the position of the maximum gain G is denoted by fw. When the center of the frequency band-width fw is denoted by the center frequency fc, a value obtained by dividing fw by fc (i.e., a normalized value of the frequency band-width by the center frequency fc) is denoted by a fractional band-width fb.

One of the most important properties of the ultrasonic transducer 100 is a gain G. The gain G indicates an efficiency of converting between an electric energy and a mechanical energy such as sound waves in both directions. For this reason, it is preferable to make the gain G of the ultrasonic transducer 100 as high as possible from the viewpoint of increasing transmission efficiency and detecting very faint sound signals.

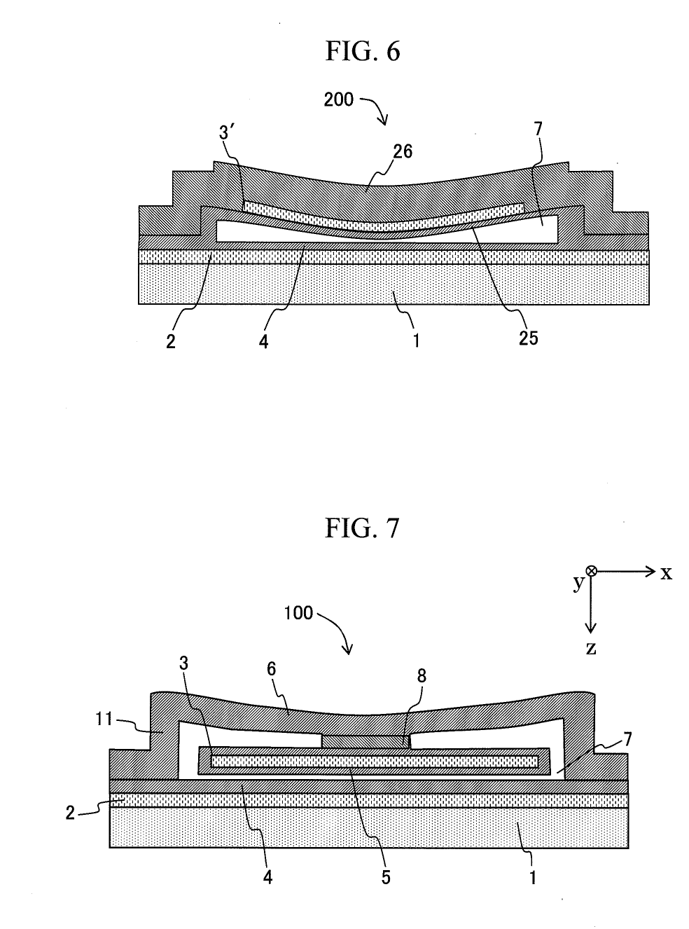

Hereinafter, descriptions will be provided for a principle of how the present invention increases the gain G. FIG. 6 shows a state in which a diaphragm is displaced by giving a potential difference to an electrode 2 and an electrode 3′ on a diaphragm side in an existing ultrasonic transducer 200. The electrode 3′ on the diaphragm side is embedded in the diaphragm 26 as shown in the drawing. When a potential difference is given to the electrode 2 and the electrode 3′ on the diaphragm side in the existing ultrasonic transducer 200, an electrostatic force acting between the electrodes displaces the diaphragm 26 as shown in FIG. 6. At this time, since a center portion of the diaphragm 26 structurally has smaller stiffness than a perimeter portion thereof at which the diaphragm is fixed, the center portion is displaced more largely than the perimeter portion. When ε denotes an effective dielectric constant between the electrodes; S denotes an electrode area, d denotes an inter-electrode distance; Vdc denotes a difference between direct potentials applied to the electrodes; Vac denotes a time-varying voltage applied between the electrodes; and a time t is a variable, the electrostatic force Fe acting on the diaphragm is expressed by the following formula:

Fe(t)≈εS*Vdc*Vac(t)/d² (1).

As shown in this formula (1), the electrostatic force has a property of increasing as the inter-electrode distance d decreases when the applied voltage and the electrode area are kept constant. Accordingly, in the structure of the existing ultrasonic transducer, the electrostatic force around the center portion of the diaphragm is larger than that around the perimeter portion.

A transmit sound pressure is almost proportion to the electrostatic force acting on the diaphragm. Here, the transmit gain Gt is defined as a sound pressure generated in response to the time-varying voltage Vac. As is clear from the formula (1), the transmit gain Gt increases according to a decrease of the distance d. Inversely, when d decreases, the diaphragm can be operated with a smaller voltage to generate the same level of sound pressure.

FIG. 7 shows a state in which the diaphragm is displaced by giving a potential difference to the electrode 2 and the electrode 3 of the ultrasonic transducer 100 according to the present invention. As compared with the existing ultrasonic transducer 200, in the present invention, the electrode 3 that forms a pair with the electrode 2 is not completely integrated with the diaphragm 6. The electrode 3 is separated from a perimeter portion of the diaphragm but still is coupled to a part of the diaphragm 6 through the binding site 8. As a result, when the diaphragm in the ultrasonic transducer 100 is displaced, the center portion of the diaphragm 6 is displaced largely, but a portion including the electrode 3 that constitutes the capacitor is displaced almost in parallel with the electrode 2, as shown in FIG. 7. In other words, unlike the existing ultrasonic transducer 200, not only the center portion of the electrode but also the perimeter portion of the electrode can be displaced largely, so that the inter-electrode distance d can be made smaller. This increases the electrostatic force applied to the diaphragm and thereby enables improvement of the transmit gain Gt.

On the other hand, when Cdc denotes the capacitance of the ultrasonic transducer at a time of applying the direct current voltage Vdc; and Δd denotes a displacement amount of the diaphragm in response to an incidence of sound waves, a receive gain Gr is expressed by the following formula:

Gr∝Cdc*Δd/d*Vdc (2).

As understood from the formula (2), in the case of ultrasonic transducers having the same direct applied voltage and the same capacitance, the receive gain Gr also reaches a higher value as the inter-electrode distance d decreases.

As has been described above, it is obvious that, given the same electrode area and the same applied voltage, the transmit gain Gt and the receive gain Gr become higher as an area with a small inter-electrode distance increases. To put it differently, paying attention to the existing structure in which the diaphragm is not allowed to be displaced at the perimeter portion thereof even through being provided with the cavity 7 that is large enough to allow the displacement, the effectiveness of the present invention is based on the structure in which even the perimeter portion of the diaphragm is allowed to be displaced sufficiently by making the most use of the cavity 7.

Next, the dimensions of the binding site 8 are described. For the purpose of the present invention, a width, in a horizontal direction, of the binding site 8 naturally needs to be smaller than a width, in the horizontal direction, of the electrode 3 or a film coating the electrode 3. In addition, the following descriptions are provided for conditions for determining the dimensions of the binding site from the viewpoint of basic properties required for the ultrasonic transducer.

A frequency band-width is another important basic property of the ultrasonic transducer 100 other than the gain G. There is a certain frequency band of interest when the ultrasonic transducer 100 is used. An increase of this frequency band-width decreases the duration of the waveform of sound waves radiated from the ultrasonic transducer 100 and the duration of the time waveform of electrical signals at the time of reception. With a smaller duration of the time waveform, the ultrasonic probe or the like is capable of observing substances inside a medium with higher resolution. In addition, with a wider frequency band-width, signal processing using various frequency bands can be performed, and thereby practically more advantageous effect is produced.

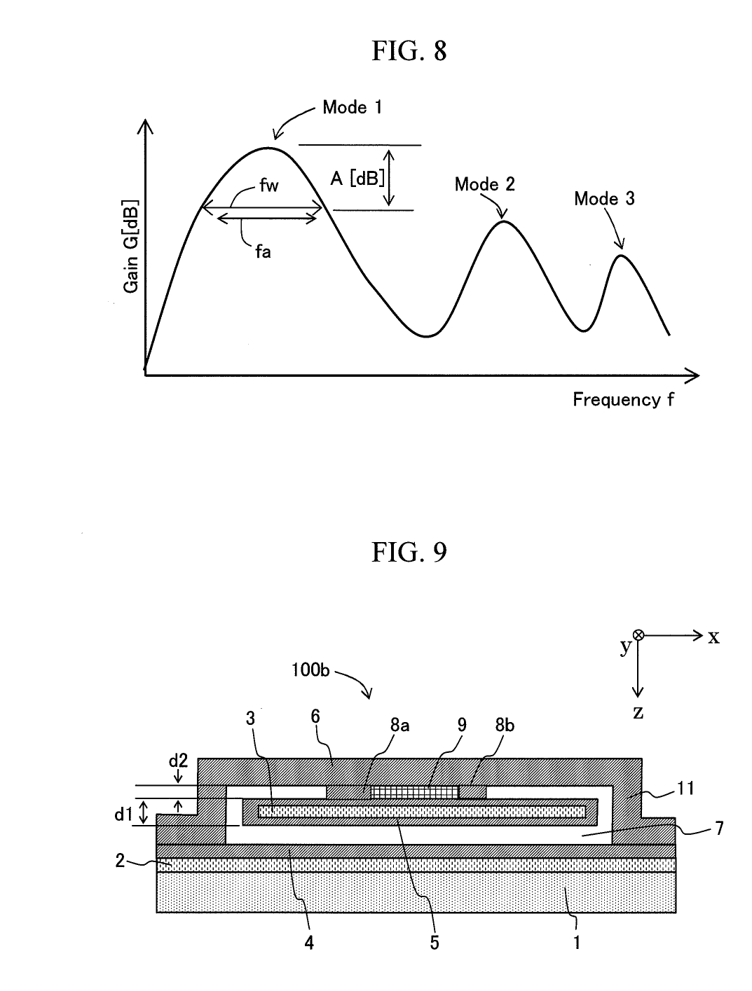

In a capacitance-type transducer, various vibration modes occur because the diaphragm is vibrated. Due to the occurrence of these vibration modes, the frequency property of the gain has multiple peaks corresponding to the modes, as shown in FIG. 8. Accordingly, to the structure of the ultrasonic transducer 100, a band-width in which the ultrasonic transducer 100 has a practically effective gain within the used frequency band needs to be surely provided as wide as necessary to satisfy the use purpose. For instance, in FIG. 8, when a mode 1 exists in the used band and when the effective gain is within a range of A [dB] from the maximum gain, the ultrasonic transducer 100 needs to be surely provided with a band-width fw that is sufficiently wide for the use (for example, fa in FIG. 8). The effective gain herein, however, is not determined only by the ultrasonic transducer but determined by the performance of the entire device, because the effective gain is changeable relatively freely by use of various electric circuit filters or signal processing.

As shown in FIGS. 1 and 2, in the present invention, the electrode 3 on the diaphragm side is separated from the perimeter portion of the diaphragm, and is coupled to the diaphragm 6 through the binding site 8. For the purpose of the present invention, the width of the binding site 8 in the horizontal direction (wx2 or wy2 in FIG. 2) is naturally smaller than the width of the cavity 7 in the horizontal direction (wx0 or wy0 in FIG. 2). This structure has lower stiffness at the binding site 8 than that before the electrode 3 is separated. For this reason, a natural vibration newly occurs at the binding site 8. This natural vibration changes the position and size of a gain peak corresponding to each of the modes between before and after the separation of the electrode 3. The stiffness at the binding site 8 also depends on a thickness of the binding site 8 in a vertical direction (z direction) in addition to the width of the binding site 8 in the horizontal direction (d2 in FIG. 1). Moreover, the stiffness further depends on a used material. Therefore, adjustment of the stiffness at the binding site 8 for surely obtaining the band-width sufficient for the use purpose can be made by selecting the widths of the binding site 8 in the horizontal direction and vertical direction and by selecting a material to be used.

From the viewpoint of the purpose of the present invention, however, the effect of the present invention is reduced extremely if the binding site 8 extends up to the proximity of the perimeter portion of the diaphragm 6. On the other hand, it is more advantageous to make the area of the electrode 3 largest possible within such a range that the electrode 3 can be accommodated in the cavity 7 without touching the supporting wall 11 of the diaphragm 6.

In this way, the binding site 8 may be formed of any of various materials or with any of various shapes as long as the binding site 8 is formed with a certain area or smaller with respect to the area of the electrode 3, secures the band-width sufficient for the use purpose, and is controllable in the manufacturing process. For example, a cross sectional shape of the binding site 8 in the horizontal direction may be of any of a circle and polygons such as a rectangle, a trapezoid and a triangle, or a cross sectional shape thereof in the vertical direction may not be a rectangular shape but may include a change in the thickness (vertical) direction.

Besides the binding site 8, the shape of the electrode 3 is another factor to have an influence on the frequency property. The stiffness of the electrode changes depending on the materials, the thickness and the width in the horizontal direction of the electrode 3 including the coating insulating layer, and this changes the number of natural vibrations generated, i.e., the frequency properties of the gains. As is the case with the binding site 8, however, the materials and shape of the electrode 3 can be adjusted according to the use purpose.

Hereinafter, other embodiments according to the present invention will be described with reference to FIGS. 9 to 15. The structure and operations of each of these embodiments may be principally the same as those of the first embodiment except for the following points.

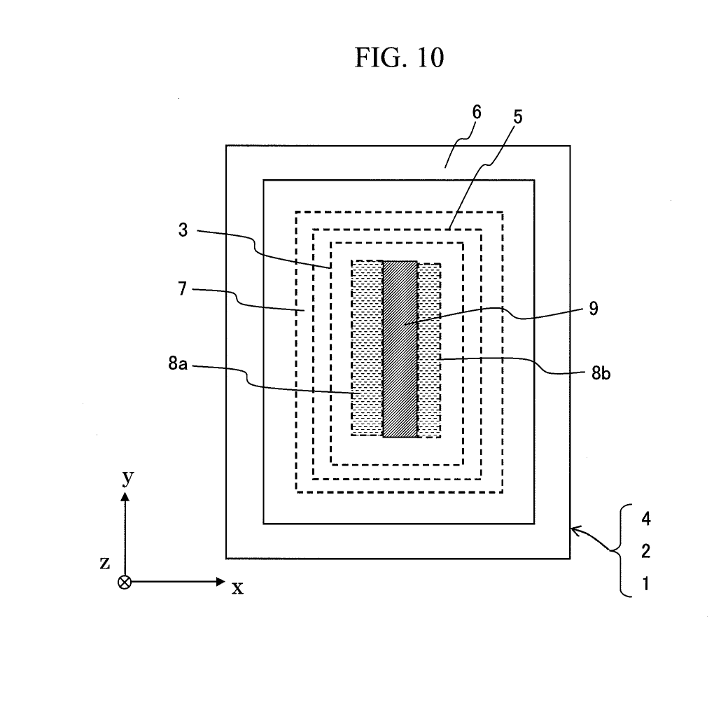

FIGS. 9 and 10 are a vertical cross-sectional view and a plan view showing an ultrasonic transducer 100b according to a second embodiment. This ultrasonic transducer 100b has a structure in which a binding site is not located in the center of a diaphragm, but is divided into multiple pieces (binding sites 8a and 8b). Even when the binding site 8 is not located in the center of the diaphragm in this way, the effect of the present invention can be produced. In addition, the multiple binding sites do not have to have the completely same shape. Moreover, a vacuum or a substance other than the binding site may be inserted as an inner layer 9 between the binding sites. For instance, what may be filled is the air or a gas, or instead is a solid matter with different properties from the binding site (for example, a matter having a sufficiently-small Young's modulus and influencing the stiffness of the binding sites 8a and 8b only to a small extent).

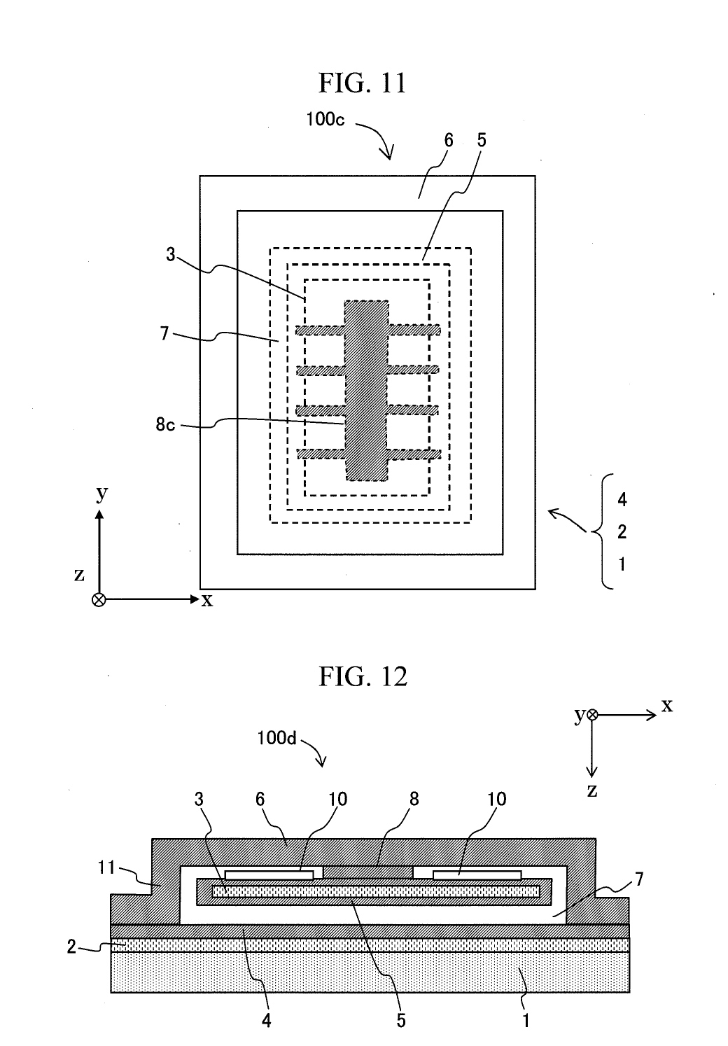

FIG. 11 is a plan view showing an ultrasonic transducer 100c according to a third embodiment. This ultrasonic transducer 100c includes a binding site 8c with a horizontal cross sectional shape in which the binding site partially juts out to extend on the electrode 3, instead of the horizontal cross section of the rectangular shape as shown in FIG. 2. By use of this embodiment, the stiffness of the electrode 3 and thus the fractional band-width can be surely obtained while the effect of the present invention is maintained. The jutting shape of the binding site shown in FIG. 11 is only one example, and any shape may be employed.

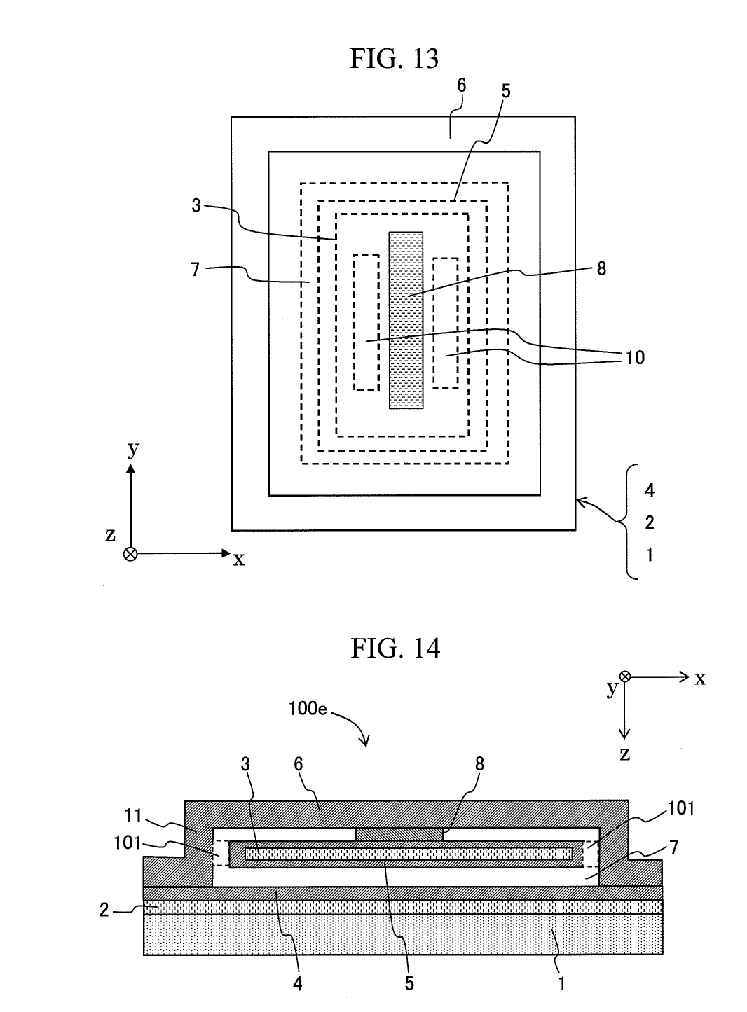

FIGS. 12 and 13 are a vertical cross-sectional view and a plan view showing an ultrasonic transducer 100d according to a fourth embodiment. This ultrasonic transducer 100d includes a stiffened element 10 at a diaphragm side of an electrode 3. The stiffened element 10 increases the stiffness of the electrode 3, and thereby produces an effect of excluding unnecessary vibration modes from the used band. This stiffened element may be provided in any number, in any shape and in any place on the electrode 3. Moreover, the stiffened element 10 may be partially in contact with the diaphragm 6 or the binding site 8. In other words, the shape of the electrode 3 is not necessarily a rectangular parallelepiped, but may be any as far as manufacturing technologies allow.

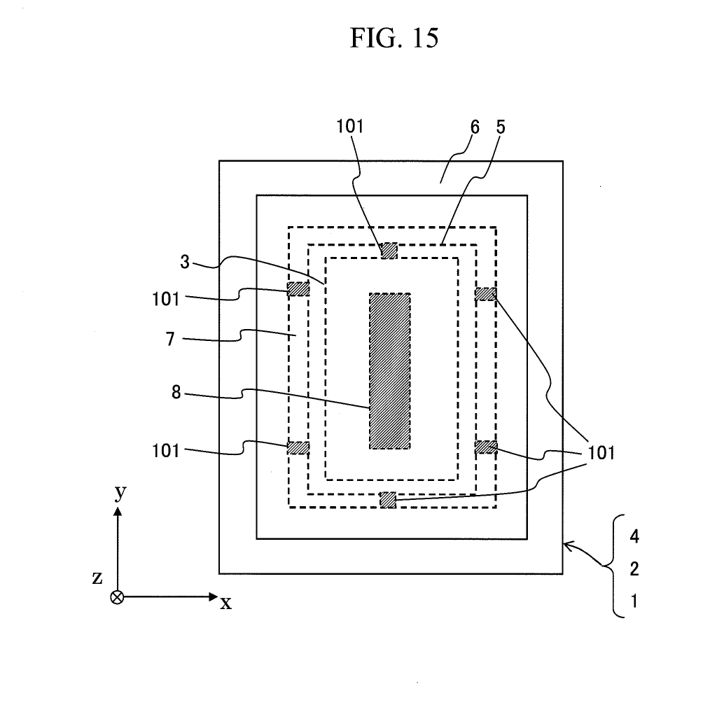

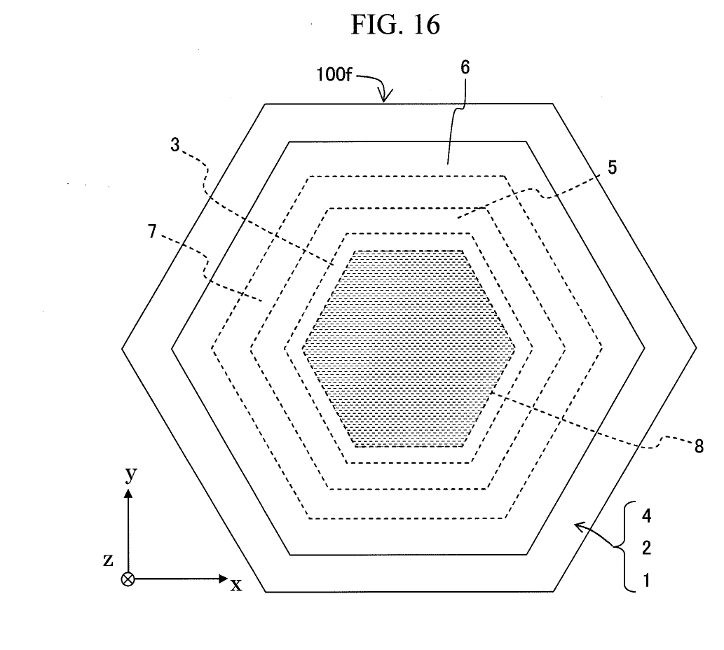

FIG. 14 is a vertical cross-sectional view showing an ultrasonic transducer 100e according to a fifth embodiment, and FIG. 15 is a plan view thereof. When the binding site 8 has a small width, the stiffness of an edge portion of an electrode 3 is decreased. For this reason, unnecessary vibrations may sometimes occur. To suppress the unnecessary vibrations, the ultrasonic transducer 100e of this embodiment has a structure in which the edge portion of the electrode 3 is partially coupled through connection regions 101 to a supporting wall 11 of a diaphragm 6 on an outer side. If the edge portion of the electrode 3 is completely coupled to the supporting wall 11 through the connection regions 101, however, the effect of the present invention is lost. Accordingly, the stiffness of each connection region 101 connecting the edge portion of the electrode 3 to the supporting wall 11 must be lower than the stiffness of the binding site 8. More specifically, the connection region 101 has to be formed to have such stiffness as to allow a portion farthest from the center of the electrode 3 to be displaced by an amount larger than a portion of the diaphragm 6 corresponding to the farthest portion of the electrode 3, when a potential difference is given to the electrode 2 and the electrode 3.

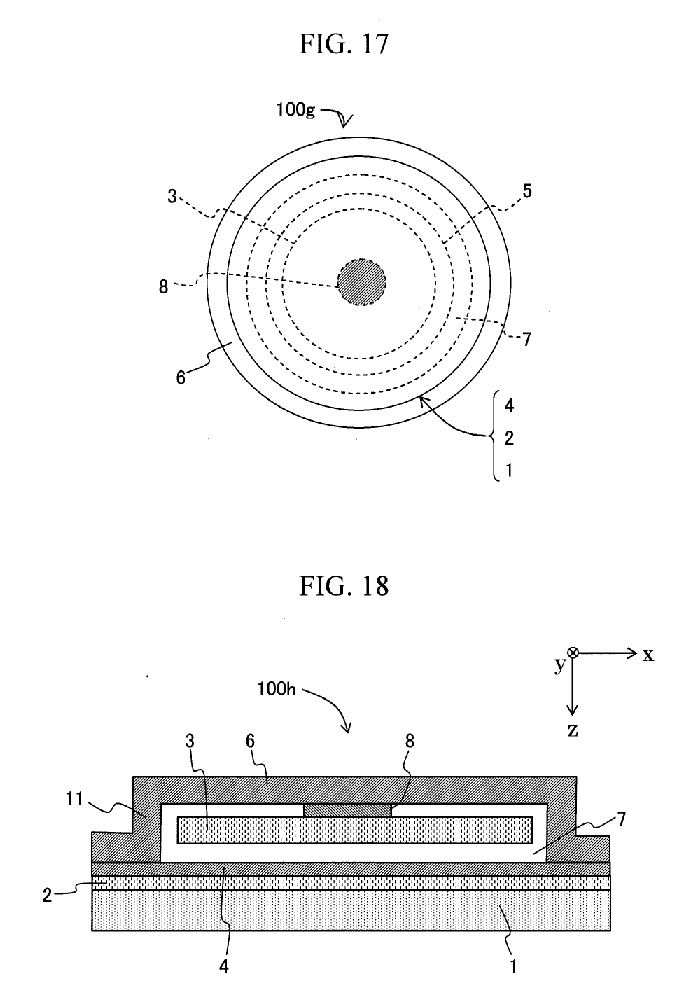

FIG. 16 is a plan view showing an ultrasonic transducer 100f according to a sixth embodiment. In this ultrasonic transducer 100f, a substrate 1, an electrode 2, an insulating layer 4, an electrode 3, a diaphragm 6, a cavity 7 and a binding site 8 have a hexagonal structure. The example shown herein is only one example, and the effect of the present invention is not impaired even with a shape other than a hexagon. For instance, the shape may be circular, as shown in FIG. 17. Moreover, the diaphragm 6 and the electrode 3 do not have to have the same shape, and the shape of each element can be selected freely. In addition, the electrode 3 and the binding site 8 do not necessarily have to have similar shapes.

FIG. 18 is a cross sectional view showing an ultrasonic transducer 100h according to a seventh embodiment. This ultrasonic transducer 100h has a structure in which an electrode 3 is not coated with an insulator. If an insulating layer 4 is placed on an electrode 2 on a substrate side and assures a high enough breakdown voltage for a time when the electrode 3 comes into contact with the substrate side, no problem should occur in the operations.

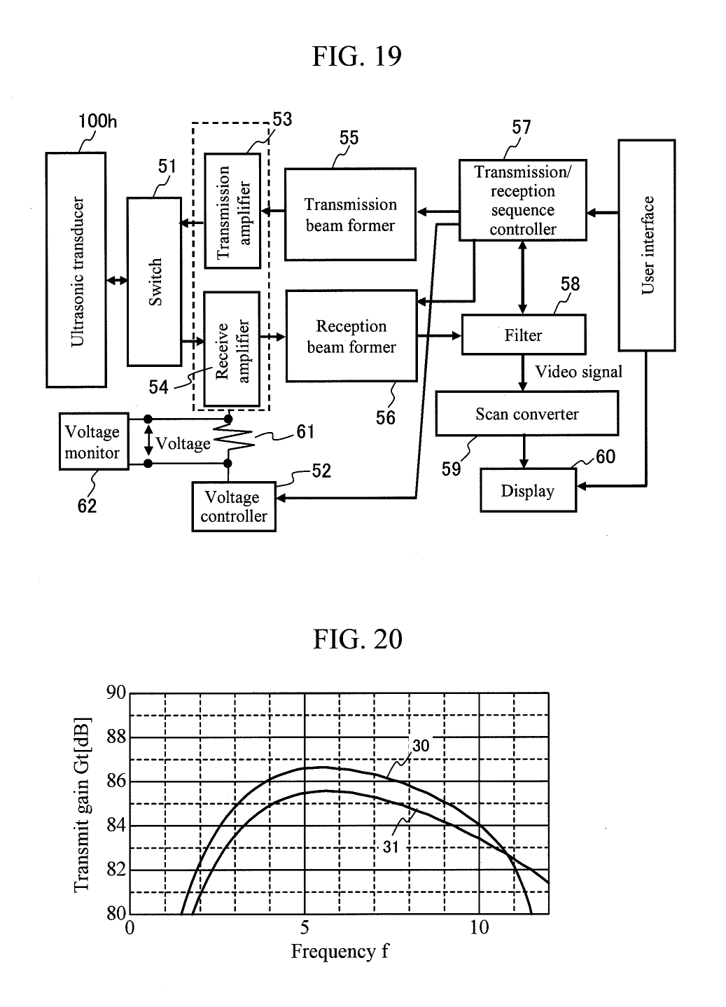

Otherwise, if the ultrasonic probe or the ultrasonic imaging device has a mechanism of detecting establishment of an electric short circuit and of preventing the short circuit from affecting the device and a medium, this transducer functions even when the insulating layer on the substrate side does not exist. For instance, as shown in FIG. 19, by inserting a resistor 61 between a voltage controller 52 and the ultrasonic transducer 100h, the system can be configured to detect the amount of an electric current flowing between the voltage controller 52 and the ultrasonic transducer 100h by means of a voltage monitor 62. With this system, the voltage applied to the ultrasonic transducer 100h can be controlled by detecting an excessive amount of electric current flowing when the electrode 3 of the ultrasonic transducer 100h comes into contact with the electrode 2, and thereby the ultrasonic transducer 100h can be operated without any problem.

Hereinafter, the present invention will be described by using a more specific example.

Design examples of the ultrasonic transducer 100 (see FIG. 1) of the first embodiment of the present invention and the existing transducer 200 (see FIG. 6) as a comparative example are described below. Then, a computer is given detailed design values and is caused to perform highly-accurate simulation of numerical values concerning properties under water.

In both the ultrasonic transducer 100 of this example and the ultrasonic transducer 200 of the comparative example, the material of the substrates 1 is Si, the material of the diaphragm 6 and the diaphragm 26 is silicon nitride (SiN), the material of the insulating layers 4, 5 and 25 is silicon oxide (SiO), and the material of the electrodes 2 and the electrodes 3 and 3′ is aluminum. In addition, the inside of the cavity 7 includes a vacuum.

The shapes in the horizontal direction are described. All elements in the ultrasonic transducer 100 of this example and the ultrasonic transducer 200 of the comparative example are designed in circular shapes. In the ultrasonic transducer 100, the maximum diameter of the cavity 7 is set to 54 μm, and the diameters of the electrodes 3 and 3′ are set to 51 μm. The diameter of the binding site 8 is set to 70% of the maximum diameter of the electrode 3. In the ultrasonic transducer 200 of the comparative example, the diameter of the cavity 7 is also set to 54 μm. The diameter of the electrode 2 is set to be the same as that of the cavity 7.

Here, the structures in the vertical direction are described. As for thicknesses, the ultrasonic transducer 100 of this example is designed to include the diaphragm 6 having a thickness of 1200 nm, the binding site 8 having a thickness of 100 nm, the insulating layer 5 between the electrode 3 and the binding site having a thickness of 800 nm, the electrode having a thickness of 400 nm, the insulating layer 5 between the electrode 3 and the cavity having a thickness of 200 nm, the cavity 7 between a lower end of the insulating layer 5 under the electrode 3 and the insulating layer 4 having a thickness of 100 nm, and the insulating layer 4 having a thickness of 200 nm. The ultrasonic transducer 200 of the comparative example is designed to include the diaphragm having a thickness of 1200 nm, the electrode 3′ having a thickness of 400 nm, the insulating layer 4 having a thickness of 200 nm, and the cavity having a thickness of 100 nm.

FIG. 20 is a graph showing the frequency properties of the transmit gains Gt under water of the ultrasonic transducer 100 of the aforementioned example and the ultrasonic transducer 200 of the comparative example. The horizontal axis indicates the frequency f, and the vertical axis indicates the gain ([dB]). In this graph, a curved line 30 shows the transmit gain property of the ultrasonic transducer 100 of this example, and a curved line 31 shows the transmit gain property of the ultrasonic transducer 200 of the comparative example.

Both of the bands of the ultrasonic transducer 100 and the ultrasonic transducer 200 (the frequency band-width within a range of −3 dB from the maximum gain for each) are approximately from 2.5 MHz to 10.5 MHz. Accordingly, the fractional band-width is obtained by dividing the band-width by the center frequency as follows:

(10.5−2.5)/((2.5+10.5)/2)*100=123%.

This proves that both of the bonds are wide enough for ultrasonic wave imaging. Moreover, as for the magnitudes of the gains, the curved line 30 shows a higher gain than the curved line 31 by approximately 2 dB, and thus, the effect of the present invention is observed.

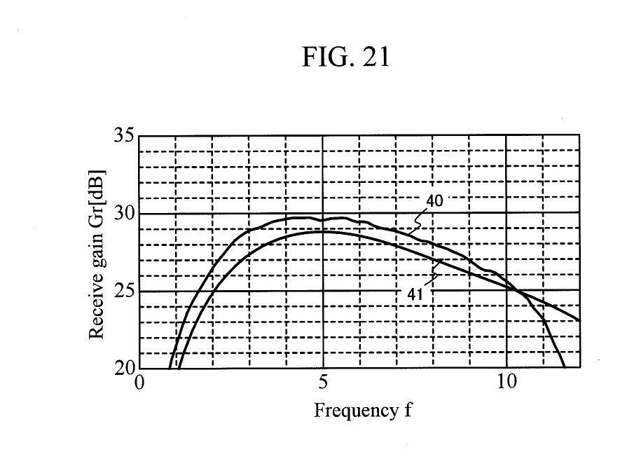

FIG. 21 is a graph showing the frequency properties of the receive gains Gr under water of the ultrasonic transducer 100 of the aforementioned example and the ultrasonic transducer 200 of the comparative example. A curved line 40 shows the transmit gain property of the ultrasonic transducer 100 of this example, and a curved line 41 shows the transmit gain property of the ultrasonic transducer 200 of the comparative example. Both of the bands of the ultrasonic transducer 100 and the ultrasonic transducer 200 (the frequency band-width within a range of −3 dB from the maximum gain for each) are approximately from 2.2 MHz to 9.2 MHz. The fractional band-width is

(9.2−2.2)/(9.2+2.2)/2*100=122%.

As for the magnitudes of the gains, the curved line 40 shows a higher gain than the curved line 41 by approximately 1 dB, and thus, the effect of the present invention is observed.

As described above, the present invention achieves gain improvement for the transmit and receive gains while having a band-width at a similar level to that of the existing ultrasonic transducer. In this example, the gain is improved by approximately 3 dB in total for the transmission and reception. When expressed as a decimal number, the gain improvement of approximately 3 dB means that the gain is improved approximately 1.4 times more. It is practically and sufficiently advantageous to provide 1.4-times more transmit and receive gain to an ultrasonic wave imaging device.

This example is only one example. By combining the foregoing embodiments having a hexagonal shape or the like, the same effect or even further gain improvement can be achieved. In addition, by changing the dimensions in the structure of the ultrasonic transducer, the properties appropriate for a use purpose can be obtained.

1. An ultrasonic probe provided with a plurality of ultrasonic transducers on a substrate, comprising
each of the ultrasonic transducers includes: an electrode provided on the substrate; a diaphragm whose perimeter portion is fixed to the substrate through a supporting wall; a cavity formed between the electrode on the substrate side and the diaphragm; and an electrode fixed to a part of the diaphragm through a binding site and arranged in the cavity.

2. The ultrasonic probe according to claim 1, wherein the electrode on the diaphragm side is coated with an insulating layer.

3. The ultrasonic probe according to claim 1, wherein that, in a direction parallel to a surface of the electrode on the diaphragm side, the binding site has a smaller width than the electrode on the diaphragm side has.

4. The ultrasonic probe according to claim 1, wherein that an insulating layer is formed on the electrode on the substrate side.

5. The ultrasonic probe according to claim 1, wherein that the binding site is provided in plurality.

6. The ultrasonic probe according to claim 1, wherein that the binding site has a circular or polygonal cross section taken in parallel with a surface of the electrode on the diaphragm side.

7. The ultrasonic probe according to claim 1, wherein that, on a surface facing the diaphragm, the electrode on the diaphragm side is provided with a stiffened element for increasing stiffness.

8. The ultrasonic probe according to claim 1, wherein that a part of a perimeter portion of the electrode on the diaphragm side is coupled to the supporting wall.

9. The ultrasonic probe according to claim 1, wherein that the diaphragm has a circular or polygonal shape.

10. An ultrasonic imaging device comprising:
an ultrasonic probe that transmits and receives ultrasonic waves to and from a test object;
an image generator that generates an image from signals acquired by the ultrasonic probe;
a display that displays the image; and
a transmission/reception sequence controller that controls a focus of the ultrasonic probe according to a depth of a measurement target portion of the test object, characterized in that
the ultrasonic probe is the ultrasonic prove according to any one of claims 1 to 9.
